(19) United States
(12) Patent Application Publication
(10) Pub. No.: US 2007/0080024 A1
(43) Pub. Date: Apr. 12, 2007

(54) Pulley assembly for a materials handling vehicle mast assembly

(76) Inventors: David Langenkamp, Carmel, IN (US); Nathan Leroy Blake, Coldwater, OH (US)

Correspondence Address: STEVENS & SHOWALTER LLP, 7019 CORPORATE WAY, DAYTON, OH, 45459-4238, US

(21) Appl. No.: 11/236,087

(22) Filed: Sep. 27, 2005

(51) Int. Cl. B66F 9/06

(52) U.S. Cl. 187/222

(57) ABSTRACT

A materials handling vehicle is provided comprising a base and a mast assembly coupled to the base. The mast assembly comprises a weldment having a pulley assembly coupled to the weldment. The pulley assembly includes a pulley element over which one or more elongated members extend, a shaft capable of being secured to the weldment prior to the pulley element being mounted to the shaft, and a retainer element for securing the pulley element to the shaft.

### CROSS REFERENCE TO RELATED APPLICATION

The present application is related to U.S. Patent Application Ser. No. ______, Attorney Docket CRN425PA, entitled “FLUID SUPPLY HOSE COUPLING STRUCTURE FOR A MATERIALS HANDLING VEHICLE,” which is filed concurrently herewith and hereby incorporated by reference herein.

### TECHNICAL FIELD

The present invention relates to a materials handling vehicle comprising a mast assembly having a weldment provided with one or more pulley assemblies, each for supporting one or more hydraulic fluid hoses.

### BACKGROUND OF THE INVENTION

Materials handling vehicles are known in the prior art comprising a base unit and a mast assembly. The mast assembly may comprise a first weldment fixed to the base unit, a second weldment movable relative to the first weldment and a third weldment movable relative to the first and second weldments. A first chain is coupled to the first weldment, extends over a first pulley element coupled to an upper portion of the second weldment and is fixed to a lower portion of a third weldment. A second chain is also coupled to the first weldment, extends over a second pulley element coupled to an upper portion of the second weldment and is fixed to a lower portion of a third weldment.

A fork carriage assembly is provided on the third weldment for movement relative to the third weldment. The fork carriage assembly may include a fork carriage, a set of forks and a conventional auxiliary device such as a carton clamp, a fork side shift device, a fork reach mechanism, a paper roll clamp, a slip sheet device or like devices. These auxiliary devices are typically actuated via a pair of hydraulic fluid lines (supply/return) coupled to each auxiliary device. Each pair of fluid lines comprises a pair of hydraulic fluid hoses extending from fixed fittings provided on the first weldment, over a pulley element provided on the upper portion of the second weldment, about a U-shaped guide block provided at the base of the third weldment, over a pulley provided on a fork carriage ram/cylinder assembly and are coupled to fittings fixed to the fork carriage of the fork carriage assembly. Further hydraulic fluid hoses extend from control valves provided on the base unit to the fittings on the first weldment. Additional hydraulic fluid hoses extend from the fittings on the fork carriage to manifolds provided on the fork carriage. Still further hydraulic fluid hoses extend from the manifolds to each auxiliary device.

Typically, the pulley element over which a pair of the auxiliary device fluid hoses extend is coupled to the second weldment via a bolt having a head and a threaded end. The pulley element coupling operation involves an operator positioning the auxiliary device fluid hoses about the pulley element, placing the pulley element, with the hoses positioned about it, adjacent the upper portion of the second weldment and threading the bolt, which extends through the pulley element, into a threaded opening in the second weldment. This coupling operation is tedious to complete as an operator must maintain the pulley element, with hoses positioned about it, next to the second weldment while threading the bolt into the weldment.

A further arrangement for supporting hydraulic fluid hoses on a mast assembly weldment is desired.

### SUMMARY OF THE INVENTION

In accordance with a first aspect of the present invention, a materials handling vehicle is provided comprising a base and a mast assembly coupled to the base. The mast assembly comprises a weldment having a pulley assembly coupled to the weldment. The pulley assembly includes a pulley element over which one or more elongated members extend, a shaft capable of being secured to the weldment prior to the pulley element being mounted to the shaft, and a retainer element for securing the pulley element to the shaft. An elongated member may comprise a hydraulic hose, electrical cable, chain, other metal cable or like member.

Preferably, an end of the shaft opposite the end secured to the weldment is substantially flush with or extends only slightly from an outer surface of the pulley element.

The shaft may comprise a bolt having a threaded first end and a second end including a slot for receiving the retainer element, which may comprise a retaining ring.

The pulley element may comprise a single pulley having at least one circumferential recessed portion for receiving at least one elongated member. Alternatively, the pulley element may comprise a single pulley having two or more circumferential recessed portions for receiving two or more elongated members.

In accordance with a second aspect of the present invention, a materials handling vehicle is provided comprising a base and a mast assembly coupled to the base. The mast assembly may comprise a weldment having first and second pulley assemblies coupled to the weldment. The first pulley assembly includes a first pulley element about which one or more hydraulic fluid hoses extend. The second pulley assembly may include a second pulley element about which a connecting member extends. The first pulley element may be nested within a portion of the connecting member extending about the second pulley element.

The first pulley assembly may further include a shaft capable of being secured to the weldment prior to the first pulley element being mounted to the shaft, and a retainer element for securing the pulley element to the shaft. Preferably, an end of the shaft opposite the end secured to the weldment is substantially flush with or extends only slightly beyond an outer surface of the first pulley element.

The shaft may comprise a bolt having a threaded first end and a second end including a slot for receiving a retainer element comprising a retaining ring.

The mast assembly may comprise one or more weldments. For example, the mast assembly may comprise first, second and third weldments. The first and second pulley assemblies may be coupled to the second weldment. The connecting member may extend from the first weldment, over the second pulley element and be fixed to the third weldment. The connecting member may comprise a chain, a cable or a like element.

The second pulley assembly may further comprise a third pulley element about which a hydraulic fluid hose extends. The third pulley element may be mounted on a common shaft with the second pulley element.

In accordance with a third aspect of the present invention, a method of assembling a pulley assembly to a mast assembly weldment of a materials handling vehicle is provided. The method comprises the steps of providing a pulley assembly including a pulley element and a shaft, coupling the shaft to a mast assembly weldment, and, thereafter, mounting the pulley element to the shaft.

The method may further comprise the step of securing the pulley element to the shaft by fastening a retainer element to the shaft.

The step of mounting the pulley element to the shaft may comprise the step of mounting the pulley element to the shaft when one or more hydraulic fluid hoses are provided about the pulley element.

An end of the shaft opposite the end secured to the weldment may be substantially flush with or extend only slightly from an outer surface of the pulley element.

### BRIEF DESCRIPTION OF THE DRAWINGS

FIG. 1 is a perspective view of a truck including a mast assembly constructed in accordance with the present invention;

FIG. 2 is an exploded view of the mast assembly of FIG. 1;

FIG. 3 is a rear perspective view of the mast assembly and fork carriage assembly lift unit of FIG. 1, with the fork carriage assembly and hydraulic fluid lines removed;

FIG. 4 is a rear view of the mast assembly;

FIG. 5 is a perspective view of an upper portion of the second weldment including the first, second, third and fourth pulley assemblies;

FIG. 6 is a rear view of the upper portion of the second weldment including the first, second, third and fourth pulley assemblies;

FIG. 7 is a rear view, partially in section of a part of the upper portion of the second weldment including the first and second pulley assemblies; and

FIG. 7A is a plan view of a retaining ring.

### DETAILED DESCRIPTION OF THE INVENTION

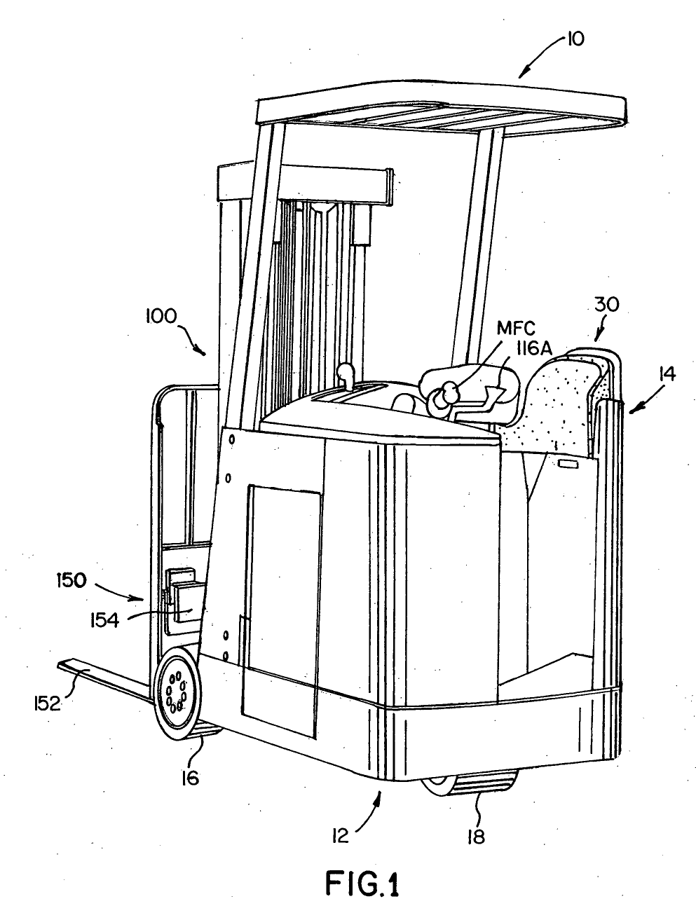

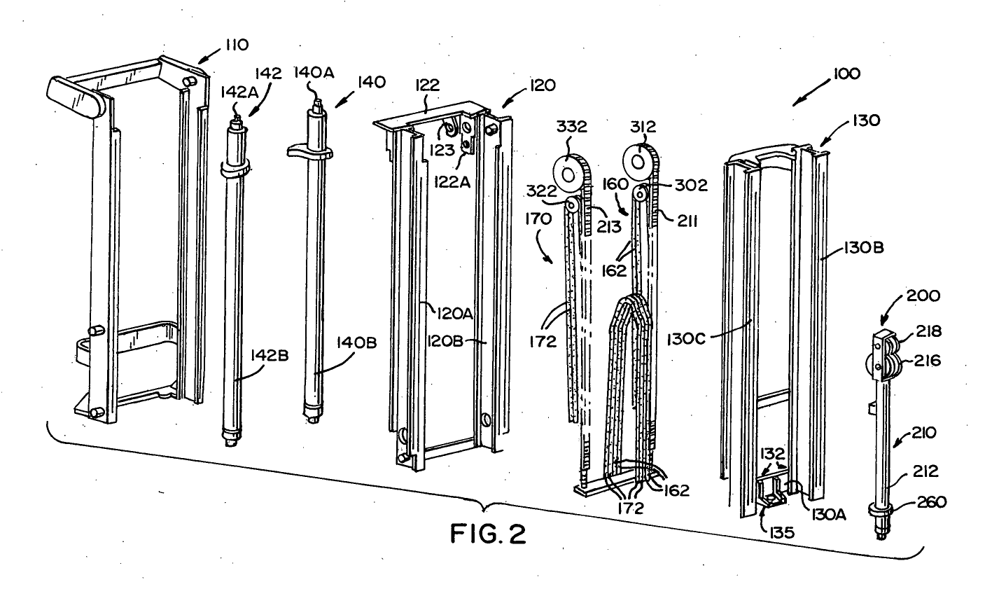

Reference is now made to FIG. 1, which is a perspective view of a three-wheel stand-up counterbalanced fork lift truck 10. A mast assembly 100, a fork carriage assembly 150 and a fork carriage assembly lift unit 200, constructed in accordance with the present invention, are incorporated into the truck 10, see also FIG. 2. While the present invention is described herein with reference to the stand-up counterbalanced truck 10, it will be apparent to those skilled in the art that the invention and variations of the invention can be more generally applied to a variety of other materials handling vehicles.

The fork lift truck 10 further includes a main body or base 12 comprising a frame 14, first and second driven wheels coupled to a front portion of the frame 14, only the first wheel 16 is illustrated in FIG. 1, and a third steerable wheel 18 coupled to a rear portion of the frame 14. The first, second and third wheels 16 and 18 allow the truck 10 to move across a floor surface.

A rider compartment 30 is located within the main body frame 14 for receiving an operator. The speed and direction of movement (forward or reverse) of the truck 10 can be controlled by the operator via a multifunction controller (MFC). Steering is effected via a tiller 116A.

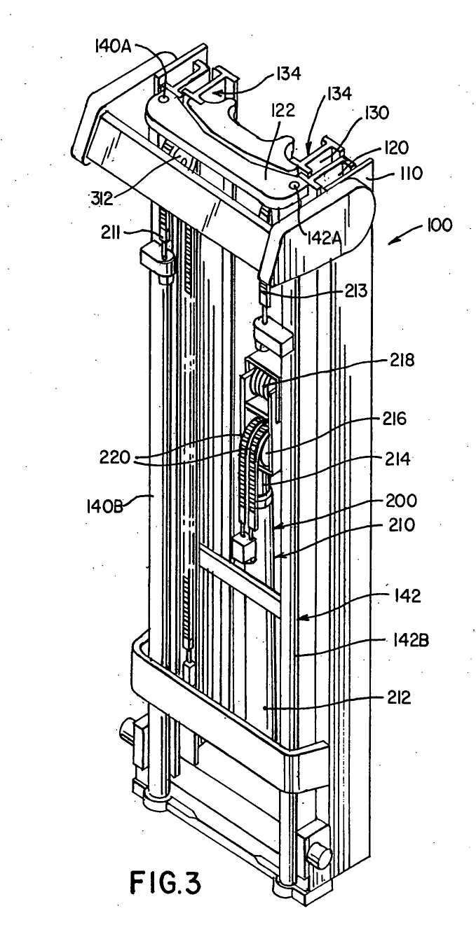

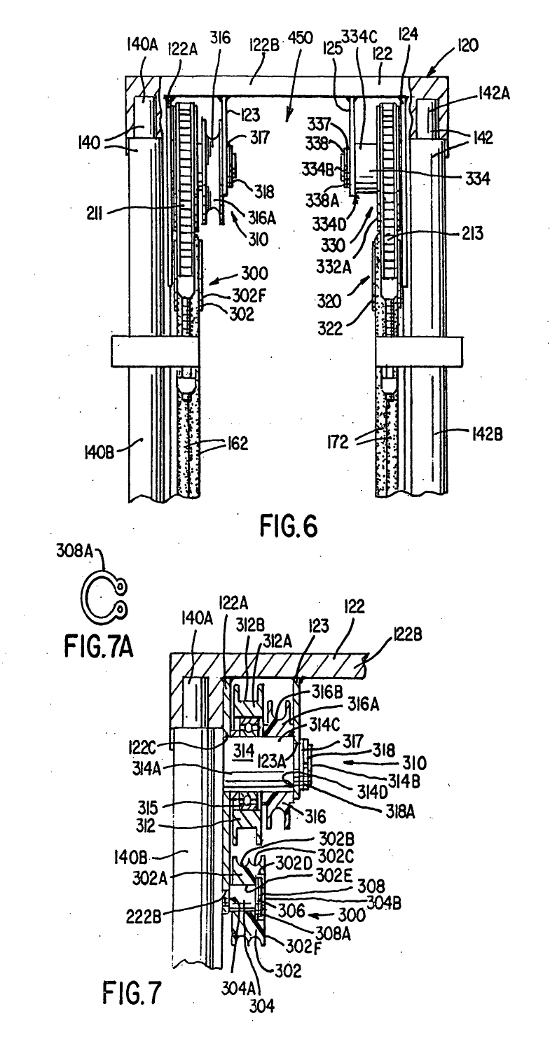

The mast assembly 100 includes first, second and third mast weldments 110, 120 and 130, see FIG. 3, where the second weldment 120 is nested within the first weldment 110 and the third weldment 130 is nested within the second weldment 120. The first weldment 110 is fixed to the truck main body frame 14. The second or intermediate weldment 120 is capable of vertical movement relative to the first weldment 110. The third or inner weldment 130 is capable of vertical movement relative to the first and second weldments 110 and 120. First and second lift ram/cylinder assemblies 140 and 142 are fixed at their cylinders 140B and 142B to the first weldment 110, see FIG. 3. Rams 140A and 142A extending from the cylinders 140B and 142B are fixed to an upper brace 122 of the second weldment 120, see FIGS. 3 and 6.

The fork carriage assembly 150 comprises a pair of forks 152 and a fork carriage 154 upon which the forks 152 are mounted, see FIG. 1 (the fork carriage assembly 150 is not illustrated in FIGS. 2 and 3). The fork carriage 154 is provided with pairs of rollers (not shown), which rollers are received in inner tracks 134 of the third weldment 130, see FIG. 3. The pairs of rollers allow the fork carriage 154 to move vertically up and down relative to the third weldment 130.

The fork carriage assembly lift unit 200 is coupled to the third weldment 130 and the fork carriage assembly 150 to effect vertical movement of the fork carriage assembly 150 relative to the third weldment 130. The lift unit 200 includes a ram/cylinder assembly 210 comprising a cylinder 212 fixed to a bracket 135, which, in turn, is fixed to a brace or plate 130A of the third weldment 130, such that it moves with the third weldment 130, see FIG. 2. A ram 214 is associated with the cylinder 212 and is capable of extending from the cylinder 212 when pressurized hydraulic fluid is provided to the cylinder 212, see FIG. 3.

First and second pulleys 216 and 218 are coupled to an upper end of the ram 214, see FIGS. 2 and 3. A pair of lift chains 220 are fixed at one end to the cylinder 212, extend over the first pulley 216 and are coupled to a lower portion (not shown) of the fork carriage 154. When pressurized fluid is provided to the cylinder 212, the ram 214 is extended causing the pulley 216 to move vertically relative to the third weldment 130. Vertical movement of the pulley 216 causes the lift chains 220 to raise the fork carriage assembly 150 relative to the third weldment 130.

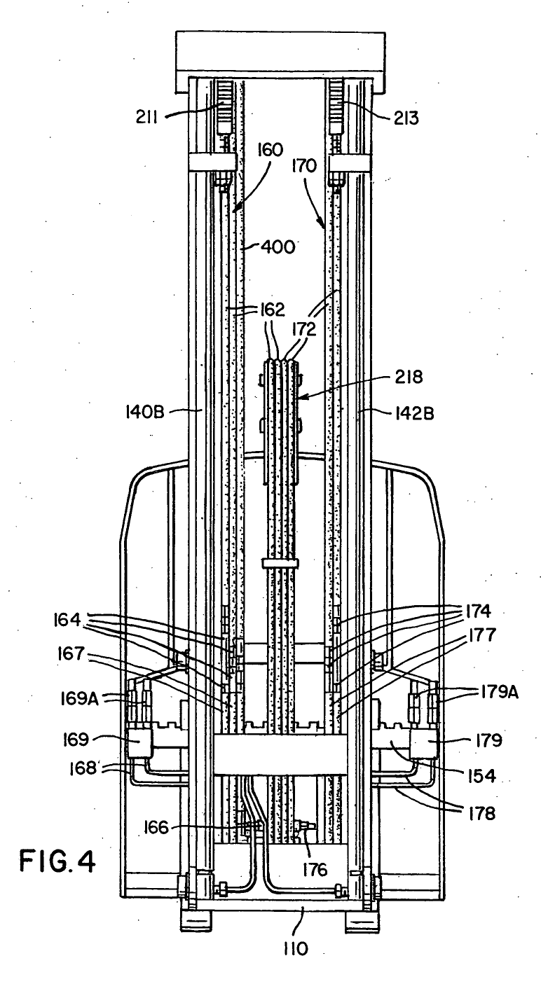

The ram/cylinder assembly 210 includes coupling structure 260, see FIG. 2, for coupling a hydraulic fluid supply hose 400, shown only in FIG. 4, to the cylinder 212. The coupling structure 260 is more explicitly described in U.S. patent application entitled “FLUID SUPPLY HOSE COUPLING STRUCTURE FOR A MATERIALS HANDLING VEHICLE,” which application has previously been incorporated by reference herein. The hose 400 forms part of a hydraulic fluid supply system, which comprises part of the lift unit 200. Operator commands for controlling the ram/cylinder assembly 210 and, hence, the vertical position of the fork carriage assembly 150 relative to the third weldment 130, are input by an operator via the multifunction controller MFC.

The fork carriage assembly 150 may further comprise one or two conventional auxiliary devices, such as a carton clamp, a fork side shift device, a fork reach mechanism, a paper roll clamp or a slip sheet device (not shown). Operator commands for controlling each auxiliary device are input by an operator via the multifunction controller MFC. Each auxiliary device is typically actuated via a pair of hydraulic fluid lines (supply/return) coupled to the device. In the illustrated embodiment, first and second pairs of hydraulic fluid lines 160 and 170 are provided for providing hydraulic fluid to two separate auxiliary devices (not shown). It is noted that zero or one auxiliary device may be provided as part of the fork carriage assembly 150 instead of two auxiliary devices.

The first pair of fluid lines 160 comprise a first pair of hydraulic fluid hoses 162 extending from fittings 164 fixed to the first weldment 110, see FIGS. 2 and 4. The first pair of fluid hoses 162 extend from the fittings 164, over a first pulley element 302 provided on an upper portion of the second weldment 120, about a first U-shaped guide block (not shown) coupled to a side of the third weldment plate 130A opposite the side to which the bracket 135 is coupled, over the second pulley 218 coupled to the upper end of the ram 214 of the ram/cylinder assembly 210 and are coupled to fittings 166 (only a single fitting 166 is shown in FIG. 4) fixed to the fork carriage 154 of the fork carriage assembly 150. A second pair of hydraulic fluid hoses 167 extend from control valves (not shown) provided on the truck base 10 to the fittings 164 on the first weldment 110. A third set of hydraulic fluid conduits 168 extend from the fittings 166 on the fork carriage 154 to a manifold 169 provided on the fork carriage 154. A fourth set of hydraulic fluid hoses (not shown) are coupled to fittings 169A provided on the manifold 169 and extend to a first auxiliary device.

The second pair of fluid lines 170 comprise a fifth pair of hydraulic fluid hoses 172 extending from fittings 174 fixed to the first weldment 110, see FIGS. 2 and 4. The fifth pair of fluid hoses 172 extend from the fittings 174, over a third pulley element 322 provided on the upper portion of the second weldment 120, about a second U-shaped guide block (not shown) coupled to the side of the third weldment plate 130A opposite the side to which bracket 135 is coupled, over the second pulley 218 and are coupled to fittings 176 (only a single fitting 176 is shown in FIG. 4) fixed to the fork carriage 154 of the fork carriage assembly 150. A sixth pair of hydraulic fluid hoses 177 extend from control valves (not shown) provided on the truck base 10 to the fittings 174 on the first weldment 110. A seventh set of hydraulic fluid conduits 178 extend from the fittings 176 on the fork carriage 154 to a manifold 179 provided on the fork carriage 154. An eighth set of hydraulic fluid hoses (not shown) are coupled to fittings 179A provided on the manifold 179 and extend to a second auxiliary device.

The mast assembly 100 may further comprise first, second, third and fourth pulley assemblies 300, 310, 320 and 330, respectively, coupled to the upper brace 122 of the second weldment 120, see FIG. 6. The first pulley assembly 300 includes the first pulley element 302 about which the first pair of hydraulic fluid hoses 162 extend, a first pulley shaft 304, a washer 306 and a retainer element 308, which, in the illustrated embodiment, comprises a spring-biased retaining ring 308A, see FIGS. 7 and 7A. In the illustrated embodiment, the first pulley element 302 comprises a single pulley 302A made from a polymeric material such as nylon 6 or Delrin (Trademark). The pulley 302A has first and second circumferential recesses 302B and 302C for receiving the two hoses 162, see FIG. 7. The pulley 302A is capable of rotating on the shaft 304 as the hoses 162 move relative to the first pulley assembly 300. It is contemplated that the first pulley element 302 may alternatively comprise two pulleys (not shown).

The pulley 302A is provided with a recess 302D centered about a bore 302E through which the first shaft 304 extends. A first vertical plate 122A of the second weldment upper brace 122 is fixedly coupled to a base plate 122B of the second weldment upper brace 122. The first shaft 304 comprises a threaded first end 304A, which is threaded into a tapped opening 222B in the upper brace vertical plate 122A. The pulley 302A is mounted on the shaft 304. The washer 306 and the retaining ring 308A are mounted to the shaft 304 to retain the pulley 302A on the shaft 304. A circumferential notch or groove (not shown) is provided in the shaft 304 for receiving the ring 308A so as to prevent axial movement of the ring 308A along the shaft 304. The length of the shaft 304 is preferably defined such that a second end 304B of the shaft 304 is substantially flush with or extends only slightly beyond an outer surface 302F of the first pulley 302A. The recess 302D allows the washer and retaining ring 308A to be placed on the shaft 304, which, in the illustrated embodiment, has a reduced length such that it does not extend beyond the first pulley outer surface 302F.

The first pulley assembly 300 is preferably mounted to the second weldment upper brace first vertical plate 122A by first threading the first shaft 304 into the first plate 122A. Thereafter, the pulley 302A, having the pair of hydraulic fluid hoses 162 positioned about it, is mounted onto the shaft 304. The washer 306 is then placed over the shaft 304 followed by the retaining ring 308A to lock the pulley 302A in position. Hence, an operator is not required to perform the tedious operation of maintaining the pulley 302A adjacent to the first plate 122A while simultaneously threading the first shaft 304 into the first plate opening 222B.

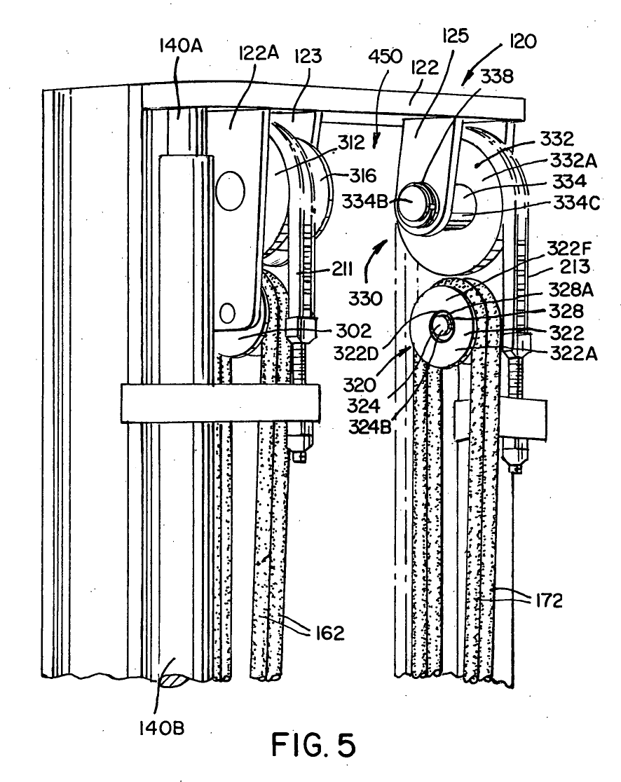

The second pulley assembly 310 includes a second pulley element 312 about which a first chain 211 extends (the chain 211 is shown in FIGS. 5 and 6 but not in FIG. 7), a second pulley shaft 314, a bearing 315, a further pulley element 316, a washer 317 and a retainer element 318, which, in the illustrated embodiment, comprises a spring-biased retaining ring 318A. In the illustrated embodiment, the second pulley element 312 comprises a single second pulley 312A formed from a metal such as steel. It comprises a circumferential recess 312B for receiving the chain 211, see FIGS. 5-7. The pulley 312A is capable of rotating on the shaft 314 via the bearing 315 as the chain 211 moves relative to the second pulley assembly 310.

In the illustrated embodiment, the further pulley element 316 comprises a single pulley 316A made from a polymeric material such as nylon 6 or Delrin (Trademark). The pulley 316A has a single circumferential recesses 316B for receiving the hose 400, shown only in FIG. 4. The pulley 316A is capable of rotating on the shaft 314 as the hose 400 moves relative to the second pulley assembly 310.

The second shaft 314 comprises a non-threaded first end 314A, which passes through a non-threaded bore 122C in the vertical plate 122A, see FIG. 7. The second shaft 314 further includes a second end 314B, which has a diameter that is less than the diameter of the first end 314A and a center portion 314C of the second shaft 314. Hence, a step 314D is defined at the junction of the center portion 314C and the second end 314B. A second vertical plate 123 of the second weldment upper brace 122 is fixedly coupled to the base plate 122B of the second weldment upper brace 122. The second end 314B of the second shaft 314 extends through a bore 123A provided in the second vertical plate 123. The second pulley 312A and the further pulley 316A are mounted on the shaft 314. The washer 317 and then the retaining ring 318A are mounted to the shaft 314. A circumferential notch or groove (not shown) is provided in the shaft 314 for receiving the ring 318A so as to prevent axial movement of the ring 318A along the shaft 314. The step 314D and the ring 318A maintain the shaft 314 in position relative to the plates 122A and 123 such that the pulleys 312A and 316A are secured on the shaft 314 between the plates 122A and 123.

The third pulley assembly 320 is constructed in substantially the same manner as the first pulley assembly 300 and is mounted to a third vertical plate 124 of the second weldment upper brace 122. The third plate 124 is fixedly coupled to the base plate 122B of the second weldment upper brace 122. The third pulley assembly 320 includes the third pulley element 322 about which the fifth pair of hydraulic fluid hoses 172 extend, a third pulley shaft 324, a washer (not shown) and a retainer element 328, which, in the illustrated embodiment, comprises a spring-biased retaining ring 328A, see FIG. 5. In the illustrated embodiment, the third pulley element 322 comprises a single pulley 322A made from a polymeric material such as nylon 6 or Delrin (Trademark). The pulley 322A has first and second circumferential recesses (not shown) for receiving the two hoses 172. The pulley 322A is capable of rotating on the shaft 324 as the hoses 172 move relative to the third pulley assembly 320.

The pulley 322A is provided with a recess 322D centered about a bore (not shown) through which the third shaft 324 extends. The third shaft 324 comprises a threaded first end (not shown), which is threaded into a tapped opening (not shown) in the upper brace third vertical plate 124. The pulley 322A is mounted on the shaft 324. The washer and the retaining ring 328A are mounted to the shaft 324 to retain the pulley 322A on the shaft 324. A circumferential notch or groove (not shown) is provided in the shaft 324 for receiving the ring 328A so as to prevent axial movement of the ring 328A along the shaft 324.

The length of the shaft 324 is preferably defined such that a second end 324B of the shaft 324 is substantially flush with or extends only slightly beyond an outer surface 322F of the first pulley 322A. The pulley recess 322D allows the washer and retaining ring 328A to be placed on the shaft 324.

The third pulley assembly 320 is preferably mounted to the second weldment upper brace third vertical plate 124 by first threading the third shaft 324 into the third vertical plate tapped opening. Thereafter, the pulley 322A, having the pair of hydraulic fluid hoses 172 positioned about it, is mounted onto the shaft 324. The washer is then placed over the shaft 324 followed by the retaining ring 328A to lock the pulley 322A in position.

The fourth pulley assembly 330 includes a fourth pulley element 332 about which a second chain 213 extends, a fourth pulley shaft 334, a bearing (not shown), a washer 337 and a retainer element 338, which, in the illustrated embodiment, comprises a spring-biased retaining ring 338A. In the illustrated embodiment, the fourth pulley element 332 comprises a single fourth pulley 332A formed from a metal such as steel. It comprises a circumferential recess (not shown) for receiving the chain 213. The pulley 332A is capable of rotating on the shaft 334 via the bearing as the chain 213 moves relative to the fourth pulley assembly 330.

The fourth shaft 334 comprises a non-threaded first end (not shown), which passes through a non-threaded bore (not shown) in the third vertical plate 124. The fourth shaft 334 further includes a second end 334B, which has a diameter that is less than the diameter of the first end and a center portion 334C of the second shaft 314. Hence, a step 334D is defined at the junction of the center portion 334C and the second end 334B. A fourth vertical plate 125 of the second weldment upper brace 122 is fixedly coupled to the base plate 122B of the second weldment upper brace 122. The second end 334B of the fourth shaft 334 extends through a bore (not shown) provided in the fourth vertical plate 125. The fourth pulley 332A is mounted on the shaft 334. The washer 337 and then the retaining ring 338A are mounted to the shaft 334. A circumferential notch or groove (not shown) is provided in the shaft 332 for receiving the ring 338A so as to prevent axial movement of the ring 338A along the shaft 334. The step 334D and the ring 338A maintain the shaft 334 is position relative to the plates 124 and 125.

The first chain 211 is fixed to the cylinder 140b of the first ram/cylinder assembly 140 and the second chain 213 is fixed to the cylinder 142b of the second ram/cylinder assembly 142, see FIGS. 4-6. The first chain 211 extends over the second pulley 312A and is coupled to a lower portion 132 of the third weldment 130, see FIG. 2. The second chain 213 extends over the fourth pulley 332A and is also coupled to the third weldment lower portion 132. The third weldment lower portion 132 may comprise lower portions of vertical rails 130B and 130C, see FIG. 2, or the lower plate 130A extending between lower portions of the vertical rails 130B and 130C of the third weldment 130. When the rams 140A and 142A of the assemblies 140 and 142 are extended, the rams 140A and 142A lift the second weldment 120 vertically relative to the fixed first weldment 110. Further, the second and fourth pulleys 312A and 332A fixed to upper brace 122 of the second weldment 120 apply upward forces on the chains 211 and 213 causing the third weldment 130 to move vertically relative to the first and second weldments 110 and 120. For every one unit of vertical movement of the second weldment 120, the third weldment 130 moves vertically two units.

The diameters of the first and second pulleys 302A and 312A and their locations relative to one another are designed such that the first pulley 302A and hoses 162 extending about the first pulley 302A are positioned directly below the second pulley 312A and nested within a portion of the first chain 211 extending about the second pulley 312A, thereby provided a larger viewing window 450 between vertical rails 120A and 120B of the second weldment 120 for an operator of the truck, see FIGS. 5 and 6. Likewise, the diameters of the third and fourth pulleys 322A and 332A and their locations relative to one another are designed such that the third pulley 322A and hoses 172 extending about the third pulley 322A are positioned directly below the fourth pulley 332A and nested within a portion of the second chain 213 extending about the fourth pulley 332A, thereby provided a larger viewing window 450 between the vertical rails 120A and 120B of the second weldment 120 for an operator of the truck, see FIGS. 5 and 6.

While the mast assembly 100 of the illustrated embodiment comprises first, second and third weldments, it is contemplated that the mast assembly may comprise two weldments or four or more weldments.

It is also contemplated that the first and third pulleys 302A and 322A may have electric cables, chains, other metal cables or like elongated members extending about them instead of hydraulic fluid hoses.

The definitions of the words or elements of the following claims shall include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Insubstantial changes from the claimed subject matter as viewed by a person with ordinary skill in the art, now known or later devised, are expressly contemplated as being equivalently within the scope of the claims.

The claims are thus to be understood to include what is specifically illustrated and described above, what is conceptually equivalent, what can be obviously substituted and also what essentially incorporates the essential idea of the invention.

What is claimed is:

1. A materials handling vehicle comprising:
a base;
a mast assembly coupled to said base, said mast assembly comprising a weldment having a pulley assembly coupled thereto, said pulley assembly including a pulley element over which one or more elongated members extend, a shaft capable of being secured to said weldment prior to said pulley element being mounted to said shaft, and a retainer element for securing said pulley element to said shaft.

2. A materials handling vehicle as set forth in claim 1, wherein an end of said shaft opposite the end secured to said weldment is substantially flush with or extends only slightly from an outer surface of said pulley element.

3. A materials handling vehicle as set forth in claim 1, wherein said shaft comprises a bolt having a threaded first end and a second end capable of receiving said retainer element comprising a retaining ring.

4. A materials handling vehicle as set forth in claim 1, wherein said pulley element comprises a single pulley having at least one circumferential recessed portion for receiving at least one elongated member.

5. A materials handling vehicle as set forth in claim 4, wherein said pulley element comprises a single pulley having two or more circumferential recessed portions for receiving two or more elongated members.

6. A materials handling vehicle comprising:
a base; and
a mast assembly coupled to said base, said mast assembly comprising a weldment having first and second pulley assemblies coupled thereto, said first pulley assembly including a first pulley element about which one or more hydraulic fluid hoses extend, said second pulley assembly including a second pulley element about which a connecting member extends, said first pulley element being nested within a portion of said connecting member extending about said second pulley element.

7. A materials handling vehicle as set forth in claim 6, wherein said mast assembly comprises a first weldment, a second weldment and a third weldment, said first and second pulley assemblies being coupled to said second weldment and said connecting member extending from said first weldment, over said second pulley element and fixed to said third weldment.

8. A materials handling vehicle as set forth in claim 6, wherein said connecting member comprises one of a chain and a cable.

9. A materials handling vehicle as set forth in claim 6, wherein said first pulley assembly further includes a shaft capable of being secured to said weldment prior to said first pulley element being mounted to said shaft, and a retainer element for securing said pulley element to said shaft.

10. A materials handling vehicle as set forth in claim 9, wherein an end of said shaft opposite the end secured to said weldment is substantially flush with or extends only slightly beyond an outer surface of said first pulley element.

11. A materials handling vehicle as set forth in claim 9, wherein said shaft comprises a bolt having a threaded first end and a second end capable of receiving a retainer element comprising a retaining ring.

12. A materials handling vehicle as set forth in claim 6, wherein said second pulley assembly further comprises a third pulley element about which a hydraulic fluid hose extends, said third pulley element being mounted on a common shaft with said second pulley element.

13. A method of assembling a pulley assembly to a mast assembly weldment of a materials handling vehicle comprising the steps of:
providing a pulley assembly including a pulley element and a shaft;
coupling said shaft to a mast assembly weldment; and, thereafter,
mounting said pulley element to said shaft.

14. The method of claim 13, further comprising the step of securing said pulley element to said shaft by fastening a retainer element to said shaft.

15. The method of claim 13, wherein said step of mounting said pulley element to said shaft comprises the step of mounting said pulley element to said shaft when one or more hydraulic fluid hoses are provided about said pulley element.

16. The method of claim 13, wherein an end of said shaft opposite the end secured to said weldment is substantially flush with or extends only slightly from an outer surface of said pulley element.
